(19) United States
(12) Patent Application Publication
(10) Pub. No.: US 2011/0114023 A1
(43) Pub. Date: May 19, 2011

(54) Method and device for treatment of animals

(76) Inventors: Thomas Mader, Rheda-Wiedenbruck (DE); Andreas Springer, Beckum (DE); Thomas Kaub, Wetter (DE)

(21) Appl. No.: 11/922,211

(22) PCT Filed: Jun. 16, 2006
(86) PCT No.: PCT/EP2006/005795

§ 371 Date: May 10, 2010

(30) Foreign Application Priority Data
Jun. 16, 2005 (DE) 10 2005 028 109.5

(51) Int. Cl. A01J 5/007

(52) U.S. Cl. 119/14.02; 119/14.08

(57) ABSTRACT

Method and device for treatment of a milk-yielding animal (10), in particular for milking an animal, in which a positioning device (16) transfers a treatment device (17) from a base position (7) to a reach position (1-S) in which an operator takes hold of the treatment device and then brings it manually to at least one teat (13, 14) of the animal to be treated. A secure reach position (6) for the treatment device and at least one comfortable reach position (1-5) for the operator are provided from which the actual reach position is chosen as a function of a characteristic parameter for a hazard potential. After the derivation of the characteristic parameter and the selection of a reach position, the treatment device is then transferred from the base position to the selected reach position.

The present invention relates to a method and an apparatus for treating animals employing an automatic positioning device wherein at least one treatment device, such as a teat cup, is transferred from a basic position to a presenting position from where the treatment device is manually brought to the teats of a lactating animal by a milker.

The present invention lies in the field of milking. In the prior art, mechanical milking systems have become known where the teat cups are manually placed on the teats of an animal to be milked by a milker. The extracting of milk is controlled mechanically. After placement there will as a rule follow first, teat stimulation and subsequently the milking process which may be terminated automatically as the milk flow dries up.

Other than these mechanical milking systems with manual placement of the teat cups, fully automatic milking systems have become known where not only stripping occurs automatically but the placement process is in particular also controlled fully automatically. Such system is e.g. disclosed in DE 39 38 077 C2, according to which each teat cup is controlled separately to be placed on the teat of the lactating animal by a teat locating device. Determining the location of the teat always occurs from an initial position in which an ultrasound sensor first performs a rough positioning and then fine positioning by means of a photoelectric matrix. Teat location by way of a laser triangulation sensor or a vision system is also known from other systems. It is a drawback that the distance from the teat is relatively long such that the placement process is not time-efficient.

From DE 600 13 400 T2, a fully automatic, robot-assisted milking system is known which establishes various animal classes associated with different sequences of movement in placement wherein said sequences of movement are as a rule a great deal broader in a basic class than in further classes. This is why the basic class requires considerably more time for placement than do the other classes. Selecting a sequence of movement from the basic class is, however, useful in the case that the probable teat position is unknown or with a restless animal because then, a specific sequence of movement may not be capable of locating a teat at all so as to subsequently necessitate a sequence of movement in the basic class, in which case considerably more time will be needed on the whole that could have been saved if the sequence of movement had been selected directly in the basic class. The class is selected relative to the animal body geometry and in particular relative to the shape of the udder and the teat position; it may, however, additionally be related to the behavior of the animal. Said classification is intended to achieve that the animal will not be encumbered by a corresponding sequence of movement of the automatic positioning apparatus and, that the automatic positioning apparatus will not be damaged by movements of the animal. The latter, however, applies with considerable limitations because it may happen that the animal moves or kicks at the most inconvenient time as the automatic positioning apparatus or the placement arm for the placement of the teat cup is exactly under the animal.

Therefore, according to DE 600 13 400 T2 it is not possible to prevent collision and thus injury to the animal or damage to the placement arm. A suitable sequence of movement may, however, shorten the average placement time needed.

Fully automatic systems offer the advantage that the presence of the farmer is not required during the milking process or at least not for the entire duration. However, many such systems do not involve much time-saving since a number of checking and maintenance measures need to be performed. One advantage of conventional, mechanical milking systems with manual placement is that the farmer is in direct contact with his animals on a regular basis such that he can automatically see and thus recognize udder disorders or other illness in individual animals, such as e.g. foot disease etc. in the routines of morning and evening milking. This is an advantage that automatic milking systems do not offer.

Although both automatic and conventional milking systems use an increasing number of different sensors to indicate possible illness in the animals, reliable results tend to require extensive chemical testing, often involving expensive reactants.

Another drawback is the difficulty of finding suitable criteria of distinction between healthy and sick animals, such that fully automatic systems may trigger the alarm more often than is necessary.

In conventional machine-milking the animal is often directly within sight of the farmer in the case of a sensor alarm so as to eliminate in conventional systems the additional time often required in fully automatic systems for examining the animal.

These are some of the reasons why the working time reduction in fully automatic systems is smaller than was originally expected.

One drawback of these conventional systems is, however, that in many cases the milker must move the treatment device or the treatment units, e.g. the teat cups over relatively long distances for placement such that he may tire relatively soon.

EP 1 616 483 A1 discloses a conventional milking system wherein the teat cups are passed from beneath through the standing area to a presenting position from which the milker places them manually on the teats of the animal to be milked. The drawback of this system is, however, that in the presenting position the teat cups protrude upwardly from the milking parlor floor such that the teat cups and their receiving elements are within the treading and kicking range of the animals which may lead to malfunction and damage to the apparatus and injury to the animals.

It is therefore the object of the present invention to provide a system so as to facilitate the work process while allowing the farmer to remain in contact with the animals and wherein the treatment device is protected as required.

To solve this problem the present invention indicates a method having the features of claim 1. The apparatus according to the invention is the object of claim 19. Preferred specific embodiments are the subjects of the subclaims.

The inventive method serves for treating a lactating animal and in particular for milking an animal. A positioning device transfers a treatment device from a basic position to a presenting position in which an operator takes the treatment device, bringing it manually to at least one teat of the animal to be treated or places the treatment device on the teat. A presenting position is provided which is safe for the treatment device and at least one presenting position which is comfortable to the operator, from which the current presenting position is selected in dependence on a parameter for a danger potential. Subsequently the treatment device is transferred to the current presenting position.

The invention has considerable advantages. Other than in the known prior art as to conventional milking, the presenting position will not be invariably the same but there is provided a safe presenting position or a safety position in which the treatment device is at least substantially protected from the animal, and at least one comfortable presenting position or comfort position which allows an operator to work comfortably. The decision on which presenting position to use, is dependent on the danger potential. In this way one achieves a lower failure rate of the components and a low risk of injury to the animals.

Other than in the robot-assisted prior art milking system, according to the invention the treatment device is manually transferred to the udder. Moreover, DE 600 13 400 T2 does not disclose a presenting of the teat cups but it provides a robot-assisted, computer-controlled placement process in which the sequence of movements is selected dependent on the animal geometry and possibly the animal behavior. A protected presenting position is not known from it.

The parameter for a danger potential may be referred to as a danger parameter. It defines in particular a danger potential for the animal or for the moving technical components. The greater the danger, the larger the parameter.

The presenting position selected is one of two options. Either a comfortable presenting position or a comfort position is selected, or the safe presenting position or a safety position is selected. Selection occurs in dependence on the danger potential. The safe presenting position is in particular a protected presenting position.

Another inventive configuration of the method for treating an animal provides that a positioning device transfers a treatment device from a basic position to a safe presenting position or to a comfortable presenting position wherein selection of the presenting position will be dependent on the ambient conditions and the behavior of the animal.

Preferably the treatment device is employed for a treatment process taken from a group of treatment processes comprising, cleaning the udder, cleaning the teat, milking the teat, pre-dipping, care treatment, or post-dipping.

The treatment device may be taken from a group of treatment devices comprising teat cups, teat cleaning cups, brush cleaning cups and cleaning equipment, and teat cups for dipping, and the like.

Preferably the treatment device comprises at least one teat cup, in particular two or four teat cups. The positioning device in particular serves to bring a teat cup receiver comprising all of the teat cups of a milking unit to the presenting position.

The safe presenting position is in particular independent of the body geometry of the animal to be treated. In the safe presenting position the treatment device is substantially or in particular entirely protected from actions of the animal. There is in particular precisely one safety position for all of the animals.

In preferred specific embodiments the parameter is dependent on ambient conditions. The parameter may in particular be dependent on the air temperature in the shed and/or the air humidity and/or airflow velocity and/or quantity and types of any insects present, mosquitoes etc., and on the presence of other animals. Preferably there are furthermore taken into account weather conditions such as storm, rain, snow, or thunderstorms.

The parameter is preferably dependent on a behavior class of the animal to be treated. For this purpose every animal is classified according to its behavior. This means, either a quiet animal at a low danger potential, or an animal at a higher danger potential. It is also possible to provide more than two classes. Ultimately, however, one parameter is established which characterizes either a quiet animal or a potentially restless animal.

In a preferred specific embodiment the safety position is selected in case that the parameter exceeds a predefined value.

For establishing the parameter of a danger potential, the behavior class of the animal is preferably taken into account. This will be a decision expressed in digits, either a low danger potential is present such that the comfortable presenting position is preset, or an increased danger potential is determined, and the safe presenting position is selected. The decision of selecting either the safe or the comfortable position may include, other than current data, the data history and in particular environmental influences.

In all of the cases the operator may alternatively set the presenting position manually. The operator or milker may influence or manually override a default setting. For example if the operator realizes that all of the animals are particularly quiet that day, he may preset the comfort position for particular or all of the animals. Reversely, he may preset the safety position or the safe presenting position if all of the animals are restless.

It is preferred that sensor data influence the parameter through the behavior of the animal to be treated. The sensor data captured on the animal and/or the state of the animal are in particular those taken into account for determining the parameter. The sensor data employed are preferably the body temperature or the heart rate of the animal. These data may be transferred e.g. wireless from a bolus to the control system. Other useful data further include the pacing activity of the animal determined e.g. by way of weight sensors in the standing area or step counters attached to the animal. Evaluation may include analysis of images to derive the animal activity from. Or else the duration may be assessed between positioning of the treatment device in the presenting position and recognition of milk flow etc. in past milking times. Also, the state of lactation and reproduction may be utilized.

In preferred configurations the behavior of the animals treated previously and in particular treated immediately previously is also taken into account in determining the parameter.

Preferably the behavior of the previous treatment processes and in particular the previous milking processes of the animal to be treated is taken into account in determining the parameter.

Also, the faecal evacuation behavior of the animal to be treated in previous milking processes or other treatment processes may be taken into account in determining the parameter to protect the treatment device or the teat cups from contamination.

All of these cases provide for the treatment device to be traversed upwardly from beneath through the standing area floor from the basic position to the comfortable presenting position. In this configuration also the safe presenting position provides for the treatment device to be fed from beneath through the floor. The safe presenting position may be chosen so as to dispose a portion and in particular the major portion or the entire treatment device beneath the standing area so as to rule out damage to the treatment device or the teat cups and in particular the teat cup receiver due to animals kicking or treading on it. As a rule teat cups are sufficiently sturdy to withstand the strains occurring so that they may protrude somewhat from the floor. However, as regards a receiving device for a treatment unit or a treatment device, kicking or treading or other large loads may result in malfunction and defects. This kind of defects is reliably prevented by the invention.

One advantage of feeding from beneath is that the lines leading to the treatment device can be fed directly from beneath so that they do not obstruct the vision. Also, no additional supporting arms are required which would limit the freedom of movement or obstruct the vision. Another advantage is that a stripping function can readily be incorporated in that tension is applied on the milk hoses from beneath.

The comfortable presenting position may be provided beneath the animal in all of the configurations. Or else it may be provided to the side of the animal or behind the animal.

In another configuration the treatment device is traversed from a basic position on the side to a comfortable presenting position beside or beneath the animal or behind the animal. Other than with the configuration described above, the treatment device is traversed from a basic position on the side to a comfortable presenting position near the animal which may in particular be disposed beneath or substantially beneath the animal. Traversing may occur e.g. via a pivoted arm or a supporting arm that is automatically moved toward a safe or comfortable presenting position. Again, a stripping function can readily be incorporated in that tension is applied on the milk hoses via the supporting arm.

In another possible and preferred configuration the treatment device is traversed from a basic position behind the animal to a comfortable presenting position beside or beneath the animal or behind the animal. In this case the basic position is provided behind the animal. Transferring of the treatment device may again occur e.g. through a pivoted arm or a supporting arm. Also, a stripping function may be incorporated.

The behavior of the animal is preferably determined on the basis of an evaluation by the operator. For this purpose the operator may, after treatment or after a number or after all of the treatment processes, enter into the control device an evaluation of the behavior which is then taken into account in the next milking process.

In the case that e.g. during one milking time, negative evaluations are given or determined for a number of successive animals, the safe presenting position may be set automatically for the following animals.

In the case that negative behavior is repeatedly observed, an alarm may be raised. It is also conceivable that after a specific count of negative assessments or after a specific quota of negative assessments, the safe presenting position is automatically preset for the following animals.

The comfortable presenting position may be selected in dependence on the animal geometry such that the comfortable presenting position may be matched to the individual animal.

Positioning to the comfortable presenting position may take into account the animal geometry and/or the location of the animal on the standing area. Thus there may be provided two, three, or more comfort positions in relation to the length, width, and height of the animal or the udder. For animals with high udders the comfortable presenting position is preferably higher than for animals whose udders hang lower in general.

The inventive apparatus serves for treating a lactating animal and in particular for milking an animal, comprising a positioning device, at least one treatment device and a control device by means of which the treatment device is automatically controlled to be transferred by the positioning device from a basic position to a presenting position. The treatment device can be manually brought by an operator from the presenting position to at least one teat of the animal. Said positioning device can be brought from the basic position to a presenting position that is safe for the treatment device and to at least one presenting position that is comfortable to the operator, and the control device is structured and configured such that the control device may serve to determine a danger parameter and the current presenting position can be automatically selected in dependence on a danger parameter.

The treatment device may in particular be configured as a type of teat cup or comprise at least one teat cup.

The safe presenting position is preferably independent of the body geometry of the animal to be treated.

The parameter for a danger potential may be preset or influenced by the operator via a setting device. This may occur through keyboard input, shifting a switch etc.

Preferably at least one sensor is provided for capturing the animal condition and/or at least one ambient condition.

The control device is in particular configured and structured such that the presenting position of the animal to be treated can be decided on by way of sensor data. For this purpose sensor data indicated previously are preferably employed.

A storage device is preferably provided in which a parameter is stored for the behavior of the animal to be treated and/or the animals treated immediately previously. In particular for each treatment process, a parameter is determined for the behavior of the animal to be treated and the parameter stored in the storage device is adjusted or confirmed.

In all the configurations the comfortable presenting position or presentation position is preferably provided near the edge of the milker pit such that the milker can comfortably grasp the presented treatment devices with his arms bent. In this position he can grasp the treatment devices configured e.g. as teat cups with little exertion and in a combined forwardly and upwardly movement place them on the teats of the animal. If, however, the treatment devices are positioned at such a distance that the milker must grasp the treatment devices with his arms outstretched, he will tire more easily since the strain is inconvenient.

In all of the configurations the basic position is a standby position. It is in particular a parking position in which the treatment device is stored between milking times. A rinsing unit for rinsing, cleansing and/or disinfecting the teat cups may be provided as a clean-in-place unit (CIP).

In all of the configurations it is of particular importance for the teat cup receiver or the receiver for the treatment device to be well protected from being damaged in the safe or protected presenting position.

In all of the configurations a switch or the like may be provided by means of which the operator operates the treatment device to transfer it promptly from the safe presenting position to the comfortable presenting position. The operator can then actuate e.g. a foot switch as he is ready for placing and the teat cups are rapidly lifted up to the comfortable presenting position, the milker takes and places them. The teat cup receiver is as rapidly removed out of the dangerous area so as to minimize the risk of damage.

According to a preferred specific embodiment of the present invention, the comfort position is individually adjusted, referring back to a preset value stored for the lactating animal. Correspondingly the comfort position can be automatically set individually by means of retrieval from a memory. Said memory is preferably a component of a herd management program for capturing and evaluating the data of the individual lactating animals of a herd.

The individual comfortable presenting position is preferably a position relative to the animal, in particular relative to the rear and preferably relative to the udder.

The preset value is preferably checked against the actual behavior in each treatment process for the lactating animal so as to guarantee the best possible match between the actual behavior and the preset presenting position. The behavior of the animal is stored. If the animal behaves as expected, the same presenting position will be selected in the next treatment or placement process. In the case of a deviation of the actual behavior from the preset value, the danger parameter and thus the presenting position is correspondingly adapted.

The continuous checking of the actual behavior offers the additional option to recognize herd-specific behavioral patterns and to correspondingly adapt the presenting positions. For example in summer the lactating animals may show heightened activity if they feel disturbed by increasing numbers of insects or insect bites. If such conspicuous behavior of all of the animals of a herd gets to be statistically significant, this may lead to corrections of the stored presenting positions for all of the animals in the herd.

The present invention may be employed in all of the configurations as necessary in treating and in particular in milking cows, sheep, goats, buffaloes, camels, dromedaries, yaks, elks, horses and other lactating animals.

Further advantages, details and features of the invention will now be described by way of the embodiments described below with reference to the attached figures.

These show in:

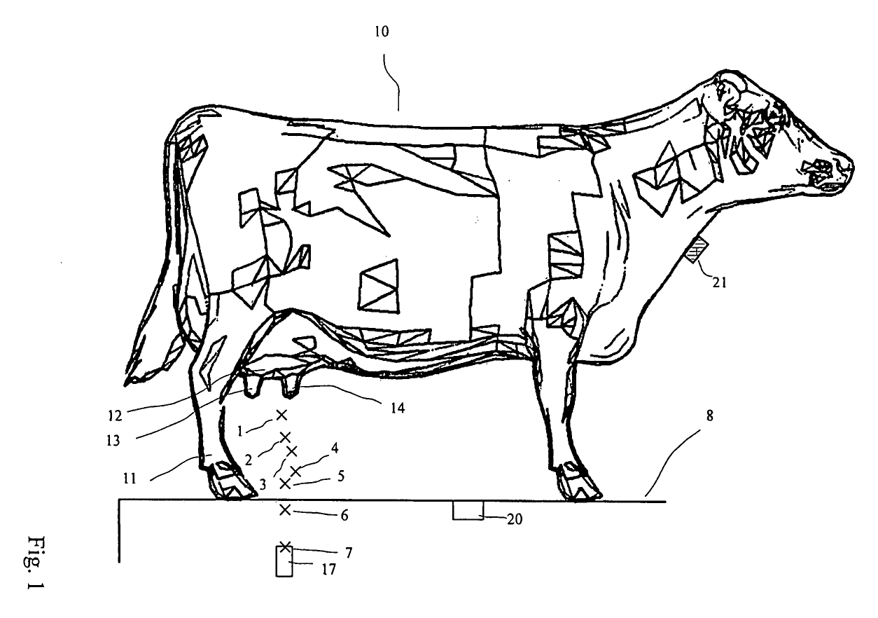

FIG. 1 a schematic illustration of the basic position, the protected, and other comfortable presenting positions;

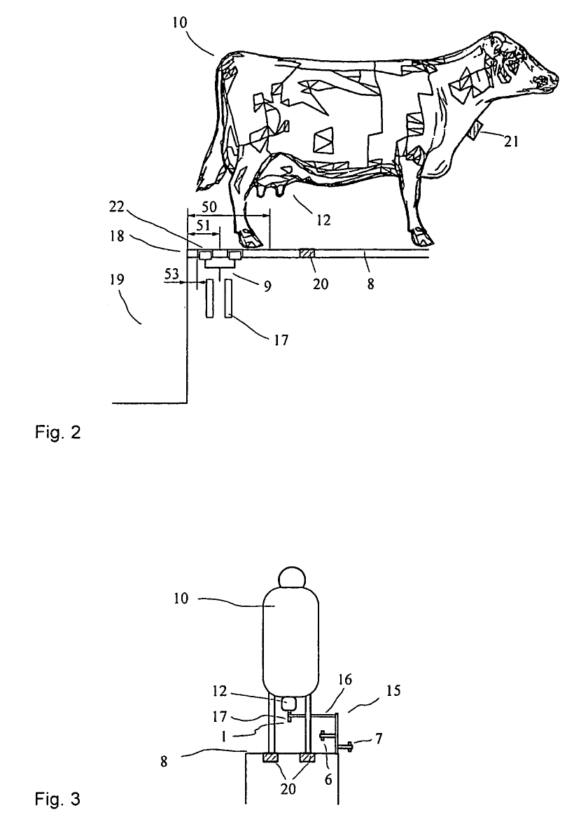

FIG. 2 a schematic side view of a milking parlor in which the teat cups are fed from beneath through the standing area; and

FIG. 3 a schematic rear view of a milking parlor in which the teat cups are transferred via a carrier device to a presenting position.

With reference to the cow 10 schematically illustrated in FIG. 1, an embodiment of the invention will now be described. The embodiment is described with reference to milking and to the placement of teat cups to the teats 13, 14 of the animals 10 to be milked. This is, however, by way of example only, the individual teats 13, 14 may likewise be cleaned or dipped.

To milk the animal 10, the teat cups 17 of the treatment device or the milking unit must be placed on the teats 13, 14 of the udder 12. For this purpose the milking unit is first traversed from the basic position 7 to one of the presenting positions 1 to 6. The presenting positions 1 to 5 are configured as comfortable presenting positions. With the teat cups there, the milker can comfortably grasp them and bring them to the udder of the animal to be milked. In the safe or protected presenting position 6 the milker can also grasp the teat cups and place them on the teats. In that position the teat cups 17 and in particular the teat cup receiver are protected such that if the animal 10 moves, it cannot do itself an injury from the teat cups and the teat cup receiver or the milking unit receiver. The technical milking components are concurrently protected from damage through treading or kicking or excessive load.

Whether the teat cups 17 are traversed to the protected presenting position 6 or to one of the comfort positions 1 to 5, is in particular dependent on the behavior of the animals. With restless animals or on days where the animals are restless, the protected position is selected because the injury potential for the animal and the danger potential for the technical components is too high. However, if an animal 10 is to be milked that is known for being quiet, one of the comfortable presenting positions 1 to 5 may be selected. The position is selected in dependence on the body geometry of the animal and the location, quality and size of the udder.

The invention facilitates work for the milker while on the other side both the technical components and the animal are optimally protected.

In the case of a new animal 10, whose behavior is not known, the protected presenting position 6 is usually first selected. The teat cups 17 are transferred to this position and from there manually grasped by the milker and placed on the teats. Selecting the safe presenting position 6 ensures an optimal protection for the teat cups 17 and the teat cup receiver.

During milking, the actual behavior of the lactating animal 10 is observed by the milker or monitored by sensors 20, which are configured to capture a wide variety of parameters on the animal and its condition and the ambient conditions. Specific sensors capture in particular the air temperature and the air humidity, and the airflow velocity in the shed. Other data may be captured on the species and quantity of any insects present. Moreover, animal-related data such as heart rate or body temperature may be captured to be emitted wireless to the control e.g. by a bolus 21. A parameter is derived from the data and the behavior which characterizes the danger potential. If the parameter exceeds a predefined value, the safe presenting position 6 is selected.

If an animal has proved to be quiet over a certain time such that there is no danger in positioning the milking unit, e.g. the comfortable presenting position 5 may be selected in the next milking operation. Or else, one of the other comfortable presenting positions 1 to 4 may be selected. This depends on the body geometry of the animal and on the specific position of the udder.

The comfortable presenting positions 1 to 5 are defined relative to one part of the animal, e.g. one teat, or relative to the udder, such that, in the presenting position 3 shown in FIG. 1 the distance to the teat may be identical for different animals although their anatomies differ.

If the animal 10 is restless or if the ambient conditions cause great unrest, a parameter will be derived that describes a higher danger potential. In this case the milking unit will not be traversed to a comfortable presenting position but to the safe, protected presenting position 6.

The milker observes the behavior of the animal and he can provide an evaluation at least in the case that the animal showed unrest or even aggression, which information will then be used in the next milking operation. Then, when the animal is quiet again for a specific number of milking operations and danger to the animal and the milking unit and the other technical components is reduced, a comfortable presenting position will be selected in the milking operation following next.

In this way, presenting and selecting of the presenting position occurs while taking into account the history and/or using sensor data on the animal and/or on the condition of the animal.

The comfortable presenting position to be selected is dependent on the animal geometry which may change over time, for example within a lactation period or over a number of lactation periods.

FIG. 2 illustrates another embodiment where the teat cups 17 are passed upwardly from beneath through openings 22 in the milking parlor floor. The distance 53 of the edge of the opening 22 in the milking parlor floor 8 to the pit edge 18 of the milker pit 19 may be small, being only e.g. 5 to 15 cm. The distance 51 of the center of the openings 22 from the pit edge 18 is smaller than the distance 50 of the center of the udder to the pit edge 18. In this way the working position will be comfortable for the milker because he may grasp the teat cups 17 in the presenting position with his arms bent. This is less tiring than grasping and lifting them with his arms outstretched.

In this embodiment, a lid 9 is provided which also comprises a cleaning unit as a clean-in-place unit. There the teat cups can be rinsed or cleaned at periodic intervals.

FIG. 3 illustrates another embodiment where the milking unit is traversed through a carrier device 15 and a supporting arm 16 from a basic position 6 to the side of the milking place to a presenting position nearer to the animal 10. In relation to the behavior of the animal, the safe presenting position 7 or a comfortable presenting position 6 may be selected.

### REFERENCE NUMERALS

1-5 comfortable presenting positions
6 protected presenting position
7 basic position
8 milking parlor floor
9 lid with cleaning unit
10 animal
11 leg
12 udder
13, 14 teats
15 carrier device
16 supporting arm
17 teat cup
18 pit edge
19 milker pit
20 sensors
21 bolus
22 opening
50 distance
51 distance
53 distance

1. A method for treating a lactating animal, in particular for milking an animal, wherein a positioning device transfers a treatment device from a basic position to a presenting position, in which an operator grasps the treatment device and then brings it manually to at least one teat of the animal to be treated, characterized in that a presenting position is safe for the treatment device and at least one presenting position comfortable to the operator is provided, from which the actual presenting position is selected in dependence on a parameter for a danger potential, wherein the treatment device is transferred thereafter from the basic position to the selected presenting position.

2. The method according to claim 1, wherein the safe presenting position is independent of the animal geometry of the animal to be treated.

3. The method according to claim 1, wherein the parameter is dependent on the ambient conditions.

4. The method according to claim 1, wherein the parameter is dependent on a behavior class of the animal to be treated.

5. The method according to claim 1 in which the safe presenting position is selected if the parameter exceeds a predefined value.

6. The method according to claim 1 wherein the operator selects the presenting position.

7. The method according to claim 1 in which data from a sensor on the behavior of the animal to be treated influence the parameter.

8. The method according to claim 1 in which data from a sensor on the condition of the animal are taken into account.

9. The method according to claim 1 in which the number of previous lactations and/or the lactation status of the animal to be treated are taken into account in determining the parameter.

10. The method according to claim 1 in which the behavior of the animals treated immediately previously are taken into account in determining the parameter.

11. The method according to claim 1 in which the behavior of the previous treatment processes of the animal to be treated is taken into account in determining the parameter.

12. The method according to claim 1 in which the faecal evacuation behavior of the animal to be treated in previous milking processes is taken into account in determining the parameter.

13. The method according to claim 1 in which the treatment device is traversed upwardly from beneath through the standing area floor from the basic position to the comfortable presenting position.

14. The method according to claim 1, in which the treatment device is traversed from a basic position to a comfortable presenting position to the side of or beneath the animal.

15. The method according to claim 1, in which the treatment device is traversed from a basic position to a comfortable presenting position behind the animal.

16. The method according to claim 1, characterized in that the behavior of the animal is determined on the basis of an evaluation by the operator.

17. The method according to claim 1 wherein after multiple successive negative evaluations, the safe presenting position is automatically preset for following animals.

18. The method according to claim 1, characterized in that the comfortable presenting position is selected in dependence on the animal geometry.

19. A device for treating a lactating animal, in particular for milking an animal, comprising a positioning device, at least one treatment device and a control device by means of which the treatment device can, being controlled automatically, be transferred by the positioning device from a basic position to a presenting position, wherein the treatment device can be manually brought by an operator from the presenting position to at least one teat of the animal, characterized in that the positioning device can be brought from the basic position to a presenting position that is safe for the treatment device and to at least one presenting position that is comfortable for the operator, wherein the control device is structured and configured such that the control device may serve to determine a danger parameter, and the current presenting position can be automatically selected in dependence on a danger parameter.

20. The device according to claim 19, wherein the safe presenting position is independent of the animal geometry of the animal to be treated.

21. The device according to claim 19, wherein the parameter for danger can be set by the operator through a setting device.

22. The device according to claim 19, wherein at least one sensor is provided for sensing the state of the animal and/or at least one ambient condition.

23. The device according to claim 19, wherein a storage device is provided in which a parameter is stored for the behavior of the animal to be treated and/or the animals treated immediately previously.

24. The device according to claim 19, wherein in each treatment process, a parameter is determined for the behavior of the animal to be treated and the parameter stored in the storage device is adjusted or confirmed.
